(19) United States
(12) Patent Application Publication
(10) Pub. No.: US 2007/0079318 A1
(43) Pub. Date: Apr. 5, 2007

(54) Method of manufacturing at least one actuator, as well as a lead frame, optical reading and/or writing head, and an optical reading and/or writing device

(75) Inventors: Jan Cornelis Van Der Hoeven, Eindhoven (NL); Johan Frederik Dijksman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/580,053

(22) PCT Filed: Nov. 15, 2004
(86) PCT No.: PCT/IB04/52417

§ 371 Date: May 22, 2006

(30) Foreign Application Priority Data
Nov. 25, 2003 (EP) 03104346.6

(51) Int. Cl. G11B 7/00; B29C 45/00

(52) U.S. Cl. 720/718; 264/328.1

(57) ABSTRACT

Method of manufacturing at least one actuator, which actuator (1) comprises at least one actuator part (2, 3) substantially made of synthetic resin, wherein a lead frame (4) comprising a number of leads (5) is provided, said synthetic resin actuator part (2,3) of said actuator (1) being injection-molded onto said lead frame (4). The invention further provides a lead frame arranged for use in such a method, a lead frame band comprising at least one such lead frame, and an optical reading and/or writing head and an optical reading and/or writing device.

### BACKGROUND OF THE INVENTION

The invention relates to a method of manufacturing at least one actuator, wherein each actuator comprises at least one actuator part substantially made of synthetic resin.

Such a method is known from the U.S. Pat. No. 5,999,501, which is incorporated herein by reference. In the known method, a plurality of elastic members is integrally molded with a lens holder and a stationary member for producing an objective lens actuator. The lens holder and stationary member are composed of resin material. Said elastic members are wires which may be made, for example, of metals. An advantage of the known method is that the actuator can be assembled in relatively few assembly steps.

A disadvantage of the known method is that it is difficult to position said wires accurately during the molding of said synthetic resin actuator part. In U.S. Pat. No. 5,999,501, positioning of the wires is achieved using a mold which makes contact with exposed parts of the wires, such that the wires are partly buried in the mold during the molding of said synthetic resin actuator part. However, such a positioning method requires complicated movements of each of the wires and the mold with respect to each other before the synthetic resin actuator part is molded. Therefore, the known method is relatively slow, leading to a low productivity.

### SUMMARY OF THE INVENTION

It is an object of the invention to provide a method according to the preamble of claim 1, wherein the at least one actuator can be manufactured with sufficiently high precision and with a high productivity.

According to the present invention, this object is achieved by the features of claim 1.

According to the invention, a lead frame, comprising a number of leads, is provided, wherein said synthetic resin actuator part of said actuator is injection-molded onto said lead frame. By using a lead frame, the leads can be moved and positioned with ease and at relatively high speed. Particularly, the lead frame provides for an in-line manufacturing process. Besides, the lead frame as such can position said leads accurately during the molding of said actuator part. Therefore, the present invention provides a relatively accurate and fast production method of said actuator.

The invention further relates to a lead frame which, according to the present invention, is characterized by the features of claim 24. Such a lead frame provides the above-mentioned advantages during use.

Furthermore, the invention provides an actuator which, according to the invention, is characterized by the features of claim 26. The actuator may be provided in a usual way with a lens holder with an objective lens and with a focusing coil and/or a tracking coil. Such an actuator can be made relatively cheap, small, lean, and precise. This actuator may be advantageously used in an optical reading and/or writing head for an optical reading and/or writing device, providing the aforementioned advantages thereto. Such a device may be further provided, as usual, with a support for an optical disc.

Further advantageous embodiments of the invention are described in the dependent claims.

The invention will now be described in more detail on the basis of exemplary embodiments shown in the accompanying drawing.

### BRIEF DESCRIPTION OF THE DRAWING

FIG. 1 is a perspective view of an embodiment of the invention;

FIG. 2 is a perspective view of the leads of the embodiment shown in FIG. 1;

FIG. 3 is a perspective view of a lead frame according to the invention;

FIG. 4 is similar view as FIG. 3 of a lead frame band comprising a number of lead frames;

FIG. 5 is a perspective view of a first manufacturing step according to the invention; and

FIG. 6 is an perspective view of a second manufacturing step.

### DETAILED DESCRIPTION OF THE PREFERRED EMBODIMENTS

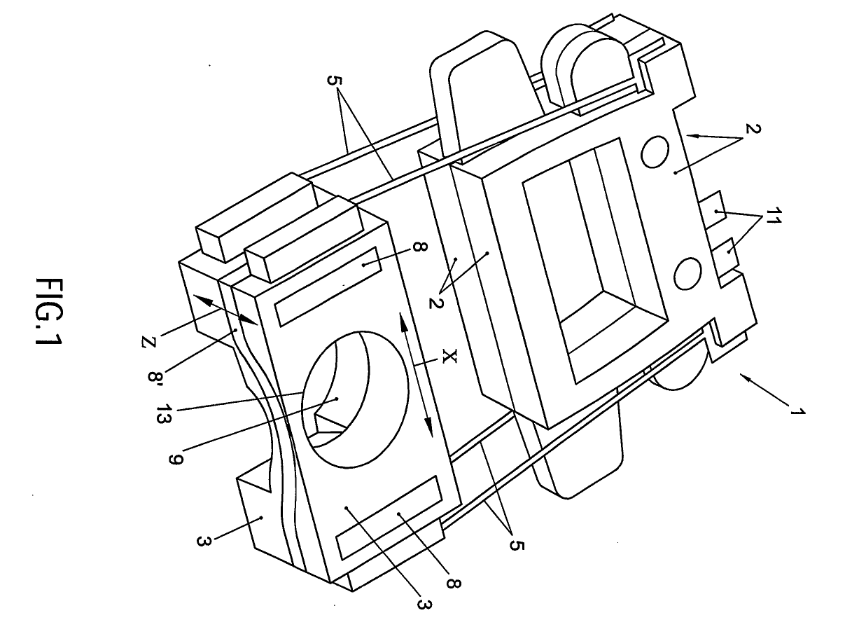

FIG. 1 shows an actuator 1, particularly for use in an optical reading and/or writing head of an optical reading and/or writing device. The actuator 1 comprises a first synthetic resin part 2 and a second synthetic resin part 3 which are movably connected to each other by elastic leads 5. Said second synthetic resin actuator part is a lens holder 3 which is provided with a transparent lens 9. Besides, the lens holder 3 is provided with electromagnets 8, 8′, comprising a pair of parallel coils 8 located on opposite sides of the lens 9. These parallel coils 8 are arranged for moving the lens holder 3, and therefore the lens 9, in a first direction X by electromagnetic force, utilizing external magnetic means which are not shown in FIG. 1. The lens holder 3 also comprises a third coil 8′ which extends substantially perpendicularly to said parallel coils 8. The third coil 8′ provides for a movement in a second direction Z of the lens holder 3, perpendicular to said first direction X, with respect to the first synthetic resin actuator part 2. The general operation of such an actuator is known from practice, see for example U.S. Pat. No. 5,999,501.

Said leads 5 provide spring means for coupling the first and second actuator part 2, 3 to each other. More particularly, the actuator 1 comprises two rows of substantially parallel leads 5 extending between said first and second actuator parts 2, 3. In the present embodiment, each row of leads comprises two leads 5.

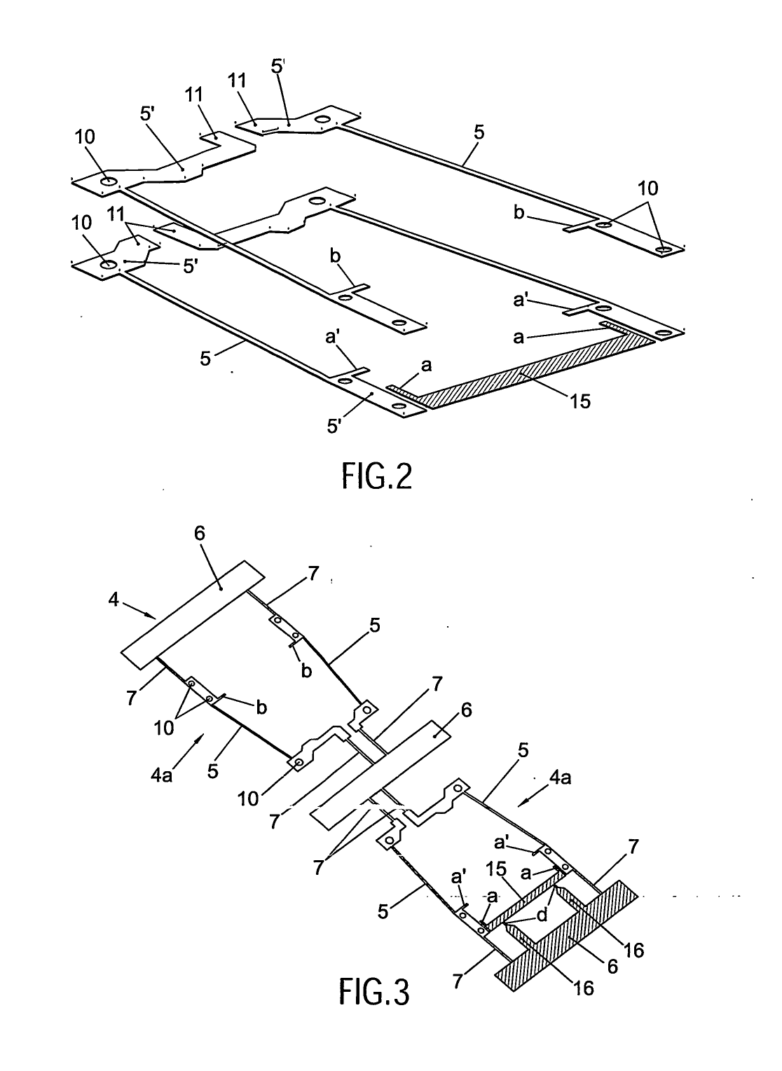

As is shown in FIG. 2, the ends of said leads 5 are integrally provided with enlarged connection parts 5′ for attaching the leads 5 firmly to said first and second actuator parts 2, 3. Said connection parts 5′ are arranged for anchoring the synthetic resin parts 2, 3. To this end, the lead connection parts 5′ comprise perforations 10 for mechanically attaching these connection parts 5′ to the first and second synthetic resin actuator parts 2, 3. Such a mechanical attachment is relatively strong. The lead connection parts 5′ may have many alternative forms and shapes for providing said anchorage. Besides, a number of the lead connection parts 5′, which are depicted on the left in FIG. 2 are provided with protruding parts 11, protruding from the first synthetic resin actuator part 2. These protruding lead parts 11 may serve, for example, for connecting external wiring or such to the leads 5. Two of said protruding lead parts 11 are shown in FIG. 1.

Furthermore, the lead frame 4 is provided with coil connection pins A, A′, B, for connection of said coils 8, 8′. Two of said coil connection pins A are provided on the ends of an elongated coil interconnecting part 15. This coil interconnecting part 15 extends between the lower of the lead connection parts 5′ which are depicted on the right in FIG. 2. These two coil connection pins A are not in direct electrical connection with the two nearby, lower lead connection parts 5′. Said lower two lead connection parts 5′ comprise coil connection pins A′. Besides, coil connection pins B are provided on the two lead connection parts 5′ extending above said lower lead connection parts 5′ in FIG. 2.

The present invention provides an advantageous method of manufacturing the actuator shown in FIG. 1. According to the invention, a lead flame 4 comprising said leads 5 is provided. One embodiment of such a lead frame 4 is shown in FIG. 3. According to the invention, said two synthetic resin actuator parts 2, 3 are simply injection-molded onto the lead frame 4, particularly in such positions that said two synthetic resin actuator parts 2, 3 are coupled to each other via a number of said leads 5. This manufacturing method will be explained in more detail below.

As is shown in FIG. 3, the lead frame 4 used in the present manufacturing method comprises a first subpart 4A and second subpart 4B. Each lead frame subpart 4A, 4B comprises two substantially parallel leads 5. The lead frame 4 further integrally comprises retaining parts 6, 7, comprising three parallel retaining strips 6 and a number of retaining leads 7. The retaining strips 6 are connected to the lead ends 5′ by said retaining leads 7 for retaining said leads 5. Said first and second lead frame subparts 4A, 4B extend between said parallel retaining strips 7. The first and second lead frame subparts 4A, 4B and said lead retaining parts 6, 7 substantially extend in the same plane. Said interconnecting part 15 is retained by one or more retaining parts 16, 6, D. Said retaining parts 6, 7, 16, D can hold the leads 5 and the coil interconnecting part 15 in desired positions during the manufacture of said actuator 1.

According to a preferred embodiment, at least some of said leads 5 are arranged for conducting at least one electrical signal. To this aim, the lead frame 4 of the present embodiment is completely made of electrically conductive material, particularly at least one metal and/or alloy. Said signal may be, for example, an actuator control signal or such.

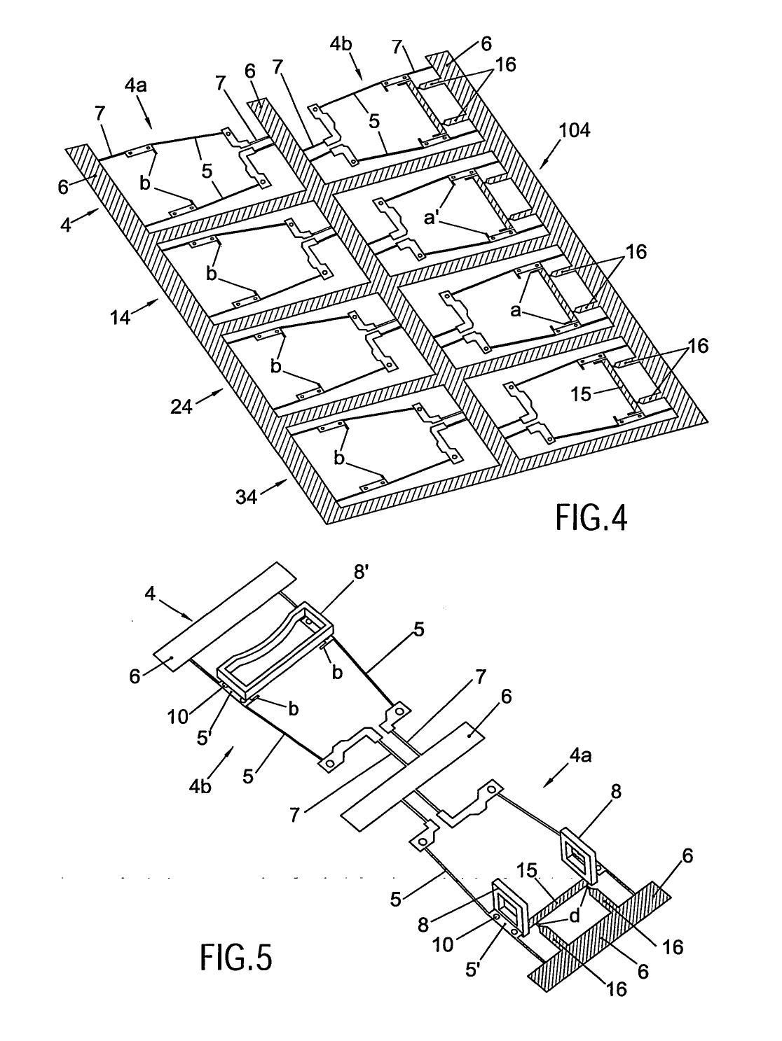

As is shown in FIG. 4, a number of lead frames 4, 14, 24, 34 can be provided in an integrally connected state, particularly as a lead frame band 104. From each of these lead frames 4, 14, 24, 34, a respective actuator 1 can be manufactured. Each lead frame can be manufactured relatively cheaply and with high precision, for example by punching each lead frame 4 and/or lead frame band 104 or by any other suitable method. Preferably, the lead frame band 104 integrally comprises a number of strengthening members 17 which extend between the lead frames 4, 14, 24, 24 for providing a relatively rigid grid which holds the lead frames. In the present embodiment, said strengthening members are reinforcement strips 17 which extend perpendicularly to said parallel retaining strips 6, 7 and attach these retaining strips 6, 7 to each other.

FIG. 5 shows a first step of the present manufacturing method, wherein a lead frame 4 is provided with said actuator coils 8, 8′. In particular, the first and second coils 8 are connected to the coil connection pins A of the coil interconnection part 15 and the coil connection pins A′ of the nearby lead connection parts 5′. One terminal of the first coil 8 is thus electrically connected to one terminal of the second coil 8 via the coil interconnecting part 15 and respective connection pins A. Each further terminal of the first and second coil 8 is connected to a lead connection part 5′ via a respective coil connection pin A′. As is shown in FIG. 5, said first and second coils 8 extend substantially perpendicularly to the plane of the lead frame 4. The two terminals of the third coil 8′ are connected to the coil connection pins B of the outer connection parts 5′ of the leads of the second lead frame part 4B, such that the third coil extends substantially parallel to the lead frame 4. Said lead connection parts 5′ and coil connection pins A, A′, B connect said coils 8, 8′ electrically to the leads 5. The spring arm leads 5 of the resulting actuator 1 can therefore serve to conduct electrical current to said coils 8, 8′ during operation of the actuator.

The connection of the coils 8, 8′ to the coil connection pins A, A′, B may be achieved, for example, by suitable welding techniques, arc welding, soldering, and the like. The coil terminals are also to be wound around the respective connection pins. In particular, said coils 8, 8′ are wire-wound coils. Preferably, self-supporting coils 8, 8′ are used so that no winding body has to be applied in the coils. From practice, several suitable types of wires are available for the production of such self-supporting coils, comprising, for example, adhesive, glue, and/or thermoplastic coatings.

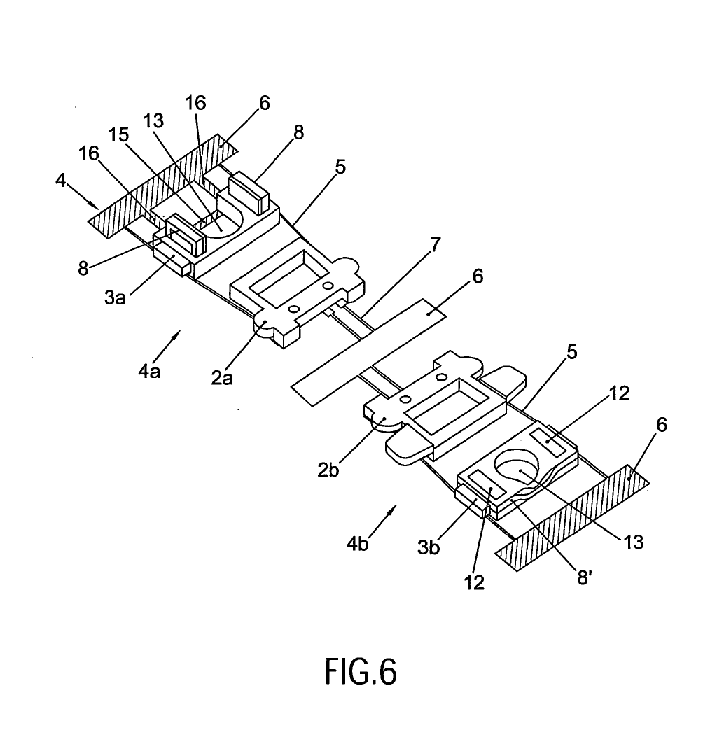

For forming the first and second synthetic resin actuator parts 2, 3, each of these parts 2, 3 is divided into a first synthetic resin subpart 2A, 3A and a second synthetic resin subpart 2B, 3B, respectively. FIG. 6 shows a second step of the present embodiment of the invention, wherein said synthetic resin actuator subparts 2A, 2B, 3A, 3B are injection-molded onto the lead frame 4, such that each synthetic resin actuator subpart is coupled to two consecutive leads 5.

Particularly, said first synthetic resin actuator subparts 2A, 3A are injection-molded on said first lead frame subpart 4A, and said second synthetic resin actuator subparts 2B, 3B are injection-molded on said second lead frame subpart 4B. The first subpart 3A of the second synthetic resin actuator part 3 is provided on the outer connection parts 5′ of the first lead frame part 4A, such that said first and second coils 8 are partially encapsulated thereby. The second subpart 3B of the second synthetic resin actuator part 3 is provided on the outer connection parts 5′ of the second lead frame part 4B, such that said third coil 8′ is at least partially encapsulated thereby. Besides, the second subpart 3B of the second actuator part 3 is provided with apertures 12 for receiving the parts of the first and second coils 8 that extend from the first subpart 3A of the second actuator part 3, as will be explained below. Besides, both subparts 3A, 3B of the second lead frame part 3 are provided with lens apertures 13, 13′ for receiving said lens 9.

FIG. 6 further shows that the first subpart 2A of the first synthetic resin actuator part 2 is provided on the inner connection parts 5′ of the first lead frame part 4A, whereas the second subpart 2B of that first actuator part 2 is provided on the inner connection parts 5′ of the second lead frame part 4B.

Since the leads 5 are retained by the retaining parts 6, 7 of the lead frame 4 during the injection-molding step of the synthetic resin actuator parts 2, 3, the actuator's dimensional accuracy is relatively high. This enables the production of relatively small actuators 1. Preferably, said first actuator subparts 2A, 3A and second synthetic resin actuator subparts 2B, 3B are molded simultaneously, so that the actuator can be manufactured relatively fast and precisely, particularly by means of the same mold. Besides, relatively few assembly parts are involved in producing the actuator 1, so that the logistics of the actuator assembly are relatively simple.

The lens 9 may be provided in said lens holder 3 in various ways. For example, the lens 9 may be a synthetic resin integrated lens which is molded in one shot with said first and/or second subparts 3A, 3B of the second synthetic resin actuator part 3. In that case, an optically suitable injection-molding polymer can be used for molding the lens. Alternatively, the lens 9 and lens holder subparts 3A, 3B are manufactured separately, after which the lens 9 is mounted in the lens holder 3.

In FIG. 6, the first and second lead frame subparts 4A, 4B are in a first position with respect to each other, particularly extending substantially next to each other in the same plane. In this first position, the lead frame subparts 4A, 4B receive said first and second synthetic resin actuator subpart 2A, 3A, 2B, 3B during the injection-molding thereof. After that, said lead frame subparts 4A, 4B are brought or folded into a second position with respect to each other for bringing said synthetic resin actuator subparts 2A, 3A, 2B, 3B together. In this second position, the first and second lead frame subparts 4A, 4B are located substantially opposite each other. Then the synthetic resin subparts of each synthetic resin actuator part 2, 3 are attached to each other, whereby the two synthetic resin actuator parts 2, 3 are formed. The synthetic resin subparts may be attached to each other in various ways, for example by adhesive material, clicking, welding, laser welding, or such. In said second position, the parts of said first and second coils 8 that project from the first subpart 3A of the second actuator part 3 are received by the coil apertures 12 of the opposite, second synthetic resin subpart 3B.

After the folding of the lead frame 4 into said second position and the formation of the two synthetic resin actuator parts 2, 3, said retaining parts 6, 7, 16, C can be removed from said lead frame subparts 4A, 4B. Removal may be achieved in various ways, for example punching, cutting, laser cutting, or any other suitable way. The resulting product is the actuator 1 as shown in FIG. 1. Alternatively, said retaining parts 6, 7, 16, C may be removed after the molding of said synthetic resin actuator subparts but before the lead frame 4 is brought into said second position.

In FIGS. 5 and 6, the manufacturing steps are shown for only a single lead frame. However, a number of integrally connected lead frames 4, 14, 24, 34 as shown in FIG. 4 may also be used. Then the different lead frames 4, 14 24, 34 can be separated from each other, for example, before or after the molding of said synthetic resin actuator subparts 2A, 2B, 3A, 3B, so that each lead frame can be brought into said second position for finishing the respective actuator 1.

Although the illustrative embodiments of the present invention have been described in detail with reference to the accompanying drawing, it is to be understood that the invention is not limited to those embodiments. Various changes or modifications may be effected by those skilled in the art without departing from the scope or the spirit of the invention as defined in the claims.

The optical element may comprise, for example, one or more lenses, optical fibers, mirrors, and/or other types of optical elements.

Besides, said actuator may be arranged and suitable for use in an optical reading and/or writing head of an optical reading and/or writing device. Besides, the actuator may serve for actuation of elements other than optical elements.

During the steps of providing the coils, synthetic resin parts, and/or any other parts onto the lead frame, the lead frame 4 may be an integral part of a lead frame band 104 or such. On the other hand, a lead frame 4 may be separated from a subsequent lead frame before it is used to receive actuator parts. Furthermore, each synthetic resin actuator part 2, 3 may be injection-molded onto more than one lead frame 4 at the same time.

Besides, the lead frame 4 may be made from any material which is suitable for the desired operation of said leads. The lead frame 4 may comprise, for example, non-polymer material. The lead frame 4 comprises a number of leads 5, for example at least one, preferably at least two, more preferably at least four, for coupling said synthetic resin actuator parts 2, 3.

Furthermore, the actuator 1 may comprise one or more electromagnets 8, 8′, which may have different, suitable positions and orientations for moving part of the actuator 1.

The injection-molding of said synthetic resin parts can be achieved with a variety of materials, for example polymer plastics or such.

Furthermore, parts of the lead frame 4 and of each synthetic resin actuator part 2, 3 may be attached to each other in various ways, for example mechanically, for example via perforations 10 in the lead frame 4, or by a suitable adhesive, or by other suitable means.

1. Method of manufacturing at least one actuator, which actuator (1) comprises at least one actuator part (2, 3) substantially made of synthetic resin, wherein a lead frame (4) comprising a number of leads (5) is provided, said synthetic resin actuator part (2, 3) of said actuator (1) being injection-molded onto said lead frame (4).

2. Method according to claim 1, wherein said actuator (1) comprises at least two separate synthetic resin parts (2, 3) which are injection-molded in such positions on said lead frame (4) that said at least two synthetic resin actuator parts (2, 3) are coupled to each other via a number of said leads (5).

3. Method according to claim 1, wherein said actuator (1) is provided with spring means (5) for coupling different actuator parts (2, 3), which spring means are provided by at least some of said leads (5) of the lead frame (4).

4. Method according to claim 1, wherein at least some of said leads (5) are arranged for conducting at least one electrical signal, said leads (5) particularly comprising an electrically conductive material, more particularly at least one suitable metal and/or alloy.

5. Method according to claim 1, wherein said lead frame (4) comprises at least one retaining part (6, 7) for retaining said leads (5), said retaining part (6, 7) being at least partially removed from said leads (5) after the molding of said synthetic resin actuator part (2, 3).

6. Method according to claim 1, wherein said at least one synthetic resin actuator part (2, 3) comprises a first synthetic resin subpart (2A, 3A) and a second synthetic resin subpart (2B, 3B), wherein said lead frame (4) comprises a first and a second subpart (4A, 4B), wherein said first synthetic resin actuator subpart (2A, 3A) is injection-molded onto said first lead frame subpart (4A), and wherein said second synthetic resin actuator subpart (2B, 3B) is injection-molded onto said second lead frame subpart (4B).

7. Method according to claim 6, wherein said first actuator subpart (2A, 3A) and second synthetic resin actuator subpart (2B, 3B) are molded simultaneously.

8. Method according to claim 6, wherein said first and second lead frame subparts (4A, 4B) are in a first position with respect to each other during the molding of said first and second synthetic resin actuator subparts (2A, 3A, 2B, 3B), for molding these synthetic resin subparts separately from each other, and wherein said lead frame subparts (4A, 4B) are brought into a second position with respect to each other after the molding of said actuator subparts (2A, 3A, 2B, 3B) for bringing said synthetic resin actuator subparts together.

9. Method according to claim 8, wherein said first and second lead frame subparts (4A, 4B) extend substantially in one plane in said first position.

10. Method according to claim 8, wherein said first and second lead frame subparts (4A, 4B) are located substantially opposite each other in said second position.

11. Method according to claim 1, wherein at least two lead frames (4, 14) are provided for manufacturing at least two respective actuators.

12. Method according to claim 11, wherein said at least two lead frames (4, 14, 24, 34) are integrally connected, for example in a lead frame band (104).

13. Method according to claim 12, wherein said at least two lead frames (4, 14, 24, 34) are separated from each other before or after the molding of said synthetic resin actuator part (2, 3).

14. Method according to claim 1, wherein said lead frame (4) comprises at least one row of leads (5), such that each at least one synthetic resin actuator part (2, 3) is coupled to at least two consecutive leads (5).

15. Method according to claim 1, wherein said at least one actuator (1) is provided with at least one electromagnet (8), particularly a coil, preferably before the molding of said synthetic resin actuator part (2, 3).

16. Method according to claim 15, wherein said electromagnet (8) is connected to at least part (5; 15) of said lead frame (4).

17. Method according to claim 4, wherein said electromagnet (8) is electrically connected to at least some of said leads (5).

18. Method according to claim 14, wherein said at least one actuator (1) is provided with at least two first electromagnets (8), and said lead frame (4) is provided with an interconnecting part (15) for connecting said first electromagnets (8) electrically to each other.

19. Method according to claim 1, wherein said actuator (1) is provided with at least one optical element (9), and wherein the actuator (1) is arranged for moving said optical element.

20. Method according to claim 19, wherein said optical element (9) is a lens, a mirror, and/or an optical fiber.

21. Method according to claim 19, wherein said optical element (9) is formed by injection-molding during the injection-molding of said synthetic resin actuator part (2, 3).

22. Method according to claim 1, wherein said actuator (1) is arranged and suitable for use in an optical reading and/or writing head of an optical reading and/or writing device.

23. Method according to claim 1, wherein said lead frame (4) is arranged for anchoring said synthetic resin actuator part (2, 3), and the lead, frame (4) particularly comprises a number of perforations (10) to provide said anchorage.

24. Lead frame, arranged for use in a method according to claim 1.

25. Lead frame band, comprising at least one lead frame according to claim 24.

26. Actuator, characterized in that the actuator (1) is manufactured by a method according to claim 1.

27. Optical reading and/or writing head comprising an actuator (1) according to claim 26.

28. Optical reading and/or writing device comprising the reading and/or writing head according to claim 27 and further comprising a support for an optical disc.

29. Method of manufacturing a lead frame according to claim 24, for example by punching the lead frame (4) and/or lead frame band.

30. Method of manufacturing a lead frame according to claim 25, for example by punching the lead frame (4) and/or lead frame band.
